(19) United States
(12) Patent Application Publication
(10) Pub. No.: US 2021/0395594 A1
(43) Pub. Date: Dec. 23, 2021

(54) HIGHLY CONDUCTIVE ADDITIVES TO REDUCE SETTLING

(71) Applicant: LORD Corporation, Cary, NC (US)

(72) Inventor: Timothy Fornes, Apex, NC (US)

(21) Appl. No.: 17/283,765

(22) PCT Filed: Oct. 10, 2019
(86) PCT No.: PCT/US2019/055514

§ 371 Date: Apr. 8, 2021

Related U.S. Application Data
(60) Provisional application No. 62/743,895, filed on Oct. 10, 2018.

(51) Int. Cl. C09K 5/14; C08K 13/04; C08K 13/06

(52) U.S. Cl. CPC C09K 5/14; C08K 13/04; C08K 13/06; C08K 7/18; C08K 2201/005; C08K 2201/011; C08K 2201/006; C08K 2201/001

(57) ABSTRACT

A composition comprising a reactive organic matrix and majority amount of large conductive particles referred to as the primary filler and a minority amount of significantly smaller conductive particles, referred to as the secondary filler. The primary filler and secondary filler are dispersed in a reactive organic matrix and the secondary filler comprises particles with anti-settling characteristics to prevent the primary filler particles from settling without compromising the overall conductivity of the composition.

### CROSS REFERENCE TO RELATED APPLICATIONS

The present application claims priority under 35 U.S.C. § 119(e) from U.S. Provisional Patent Application Ser. No. 62/743,895 filed Oct. 10, 2018, entitled “HIGHLY CONDUCTIVE ADDITIVES TO REDUCE SETTLING”, the disclosure of which is incorporated herein by reference.

### FIELD OF THE INVENTION

The invention relates to filled resin systems including a larger primary conductive filler that is prone to settling and a smaller secondary conductive filler that resists settling. The proper selection and combination of filler provides a composition that is resistant to settling yet remains highly thermally conductive.

### BACKGROUND OF THE INVENTION

The settling of (micron-sized) particles like those used to enhance the thermal conductivity of encapsulants, gap fillers, and adhesives is a ubiquitous issue that limits the commercial success of such materials. Settling can occur during the storage and transportation of the adhesive and in certain adhesive chemistries, like epoxies or urethanes, can be exacerbated by heat as this lowers the resin viscosity. The result is a material that contains a non-uniform distribution of filler that can be very difficult to re-homogenize prior to use and/or can rapidly settle during use. It is for this reason, formulators often employ small amounts of fumed silica to boost the low-shear viscosity thereby greatly reducing settling. Unfortunately, the tradeoff with this approach is loss of thermal conductivity of the material due to the relative non-conductivity of the fumed silica. This tradeoff becomes more pronounced the higher the concentration of (micron-sized) conductive particles in the original formulation.

Thus, there is a need for a non-settling or greatly reduced settling conductive formulation that does not have the trade-offs associated with prior art anti-settling aids.

### SUMMARY OF THE INVENTION

In a first embodiment of the present invention, a composition is provided comprising a reactive organic matrix and majority amount of large conductive particles referred to as the primary filler and a minority amount of significantly smaller conductive particles, referred to as the secondary filler. The primary filler and secondary filler are dispersed in a reactive organic matrix and the secondary filler comprises particles with anti-settling characteristics to prevent the primary filler particles from settling without compromising the overall conductivity of the composition.

In another embodiment of the present invention, a composition is provided comprising a reactive organic matrix, primary filler, and secondary filler, which exhibits a significant reduction in settling of the primary filler without a correspondingly significant reduction in conductivity as compared to a composition without the secondary filler. This result is achieved by using small amounts of a secondary filler comprising a thermally conductive material with a particle size much less than the primary filler and a surface area significantly larger than the primary filler. In this regard, once applied to a substrate and cured there are established direct heat transfer paths through individual filler particles from a first surface of the composition to a second surface of the composition, for example when the composition is disposed between a heat-source and heat-sink.

The small in size, but very high surface area, secondary conductive filler provides enhanced anti-settling characteristics to the composition without sacrificing the overall composition's conductivity as much as with conventional anti-settling aids, such as fumed silica. Further, the combination maintains good flow at higher shear rates and relatively high conductivity once the composition is cured. Moreover, such additives enable production of adhesives having a white or black appearance which is especially useful in assessing the degree of mixing of 2-part compositions. This invention offers a considerable advantage over prior art fumed silica additives which although they prevent settling, they negatively affect thermal conductivity. In principle, such unique additives could be used in any filled formulation that needs low settling and high conductivity regardless of resin chemistry.

In one preferred embodiment of the present invention, a composition is provided comprising, a reactive organic matrix, a thermally conductive primary filler comprising at least 50 volume percent based on the total volume of the composition, an average particle size of at least about 5 microns, and a thermal conductivity of at least about 15 W/mK, and a thermally conductive secondary filler comprising particles having an average particle size of less than 100 nm agglomerating together to form an aggregate having an irregular structure and comprising a measurement in a longest dimension of greater than 400 nm.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION

In a first embodiment of the present invention a composition is provided comprising a reactive organic matrix, a conductive primary filler and a conductive secondary filler. The primary filler provides the primary bulk thermal (or electrical) conductivity to the composition. These primary fillers are typically metals, ceramics, and glasses. Most commonly the filler comprises at least one of aluminum oxide, aluminum trihydrate (or aluminum hydroxide), aluminum nitride, magnesium oxide, zinc oxide, silicon carbide, silicon nitride, beryllium oxide, or boron nitride.

In another embodiment of the present invention, the primary filler comprises an average particle size of about 1 to about 100 microns in the largest dimension, though preferably the primary filler comprises a shape approximating a sphere. In a most preferred embodiment of the present invention, the primary filler comprises a spherical particle with a diameter of at least about 25 microns and less than about 75 microns, and a corresponding surface area of about 0.1 to 0.2 m²/g. Further, in an embodiment of the present invention, the thermal conductivity of the primary filler is at least about 20 W/m·K and preferably at least about 30 W/m·K.

In another embodiment of the present invention, the primary filler is included having two distinct particle size distributions, a larger primary filler and a smaller primary filler. To achieve efficient packing between the two particle size distributions, the larger primary filler is approximately spherical and about 10 times larger than the smaller primary filler. In this manner, the larger primary filler comprises an average particle size of about 25 to about 75 microns and the smaller primary filler comprises an average particle size of about 2.5 to about 7.5 microns.

In a further embodiment of the present invention, the secondary filler comprises a surface area of at least about 100 m²/g, preferably at least about 150 m²/g and most preferably above about 200 m²/g. The high surface area of the secondary filler provides ample interaction with the resin system to increase or thicken viscosity via secondary bonding mechanisms with the resin system (e.g. hydrogen bonding, van der Waals, etc.). In certain situations, the secondary filler may act as an associative thickener by increasing viscosity through the formation of an interconnected network of secondary filler particles. The level of thickening is enhanced by the surface area and small size (and collectively, the amount) of particles. Thickening is most pronounced in the absence of or a low amount of shear stress such as during storage or transportation of the adhesive formulation. This thickening greatly reduces or prevents settling of the primary filler particles under such conditions. Furthermore, the secondary bonding and/or associated network of secondary filler particles can easily be broken at high shear rates allowing the adhesives to readily flow during adhesive dispensing operations. In one embodiment of the present invention, the thermal conductivity of the secondary filler is at least about 10 W/m·K, preferably at least about 20 W/m·K, and most preferably at least about 50 W/m·K.

In a preferred embodiment of the present invention, the secondary filler comprises at least one of magnesium oxide, aluminum oxide, or conductive carbon black or graphite such as a furnace grade carbon black with high graphite content.

In an embodiment of the present invention, the secondary filler comprises a plurality of approximately spherical individual particles with an average particle size of less than about 100 nm, preferably about 10 nm to about 50 nm. These individual particles “clump” or agglomerate together to form particle aggregates having the high surface area described above. Further, individual particles may be physically bonded/embedded/fused within each other to form this aggregate configuration. In one embodiment of the present invention, the aggregates are irregularly shaped and about 200 nm to about 600 nm in a longest dimension, though due to their irregular shape there may be wide variance in length of the aggregates in different dimensions. In a preferred embodiment of the present invention, the aggregates are greater than about 400 nm in a longest dimension.

In this manner, the aggregates exhibit a “grape bunch-like” structure which enhances thermal conductivity between the individual particles, which further enhances the thermal conductivity between the primary filler particles when there is a continuous or near continuous path through and between the composition provided by the combination of primary filler and secondary filler.

In another embodiment of the present invention, the secondary filler comprises a mixture of at least two particle shapes so as to add to the irregularity of the secondary filler, for example long rods or a plate/planar shapes and spheres. The rods/plates typically comprise a length of about 50 nm to about several hundred nanometers. By using a mixture of differently shaped particles, the overall effect is an agglomeration of rods/plates and spheres that form a very high surface area, branched, chain-like amorphous structure.

In a further embodiment of the present invention, the secondary filler is treated to change the surface chemistry of the filler. Typically, the secondary filler will be treated to stimulate an interaction between the secondary filler and the reactive organic matrix. This provides a mechanism by which the secondary filler physically associates to form a network within the reactive organic matrix, rather than being dispersed uniformly throughout. This promotes greater contact between the individual secondary particles and between the primary filler and secondary filler to further increase the conductivity of the composition. In a specific embodiment of the present invention, the secondary filler is treated with at least one of a hydrophobic silane, a hydrophobic organo-titanate, hexamethyldisilzane, or polydimethylsiloxane.

In one embodiment of the present invention, the primary filler is present as a majority of the composition by volume. As such, the primary filler is present in an amount greater than 50 volume percent, more preferably greater than 60 volume percent, and most preferably greater than about 65 volume percent, based on the total volume of the composition.

In another embodiment of the present invention, the secondary filler is present as a substantial minority of the composition by volume. As such, the secondary filler is present in an amount less than about 1.0 volume percent, preferably less than about 0.5 volume percent, more preferably less than about 0.1 volume percent, based on the total volume of the composition. The addition of too much secondary filler causes the undesirable increases in viscosity at higher shear rates where adhesive dispensing is conducted.

In one embodiment of the present invention, the composition is thermally conductive but electrically insulative. Typical uses for thermally conductive compositions often require that they be electrically insulative, having a dielectric strength of at least 3, preferably at least 5, and most preferably at least 10 kV/mm. As such, in an embodiment of the present invention, the secondary filler may comprise an electrically conductive filler if the overall composition remains electrically insulative. As such, a highly electrically conductive secondary filler, such as silver, may be used so long as the overall composition comprises a dielectric strength of at least 3 kV/mm.

In contrast, some applications require electrical conductivity in a composition, and as such in an additional embodiment of the present invention, the primary filler comprises an electrically conductive filler, such as silver, aluminum, and the like.

The primary and secondary filler materials are incorporated into a reactive organic matrix to provide conductivity to the composition. The reactive organic matrix may be a thermosetting or thermoplastic material and may be selected from a variety of commercially-available resins and elastomers such as polyurethanes, polyimides, nylons, polyamides, polyesters, epoxies, polyolefins, polyetheretherketones, silicones, fluorosilicones, thermoplastic elastomers, acrylics, and copolymers and blends thereof.

In a preferred embodiment of the present invention the reactive organic matrix comprises an epoxy resin, though systems build on other resin and polymeric chemistries can utilize the same filler combinations to arrive at similar properties. Typically, the reactive organic matrix is present in an amount less than 50 volume percent, preferably less than 40 volume percent, and more preferably about 35 volume percent, based on the total volume of the composition.

In another embodiment of the present invention, the composition further comprises a curative and optionally a catalyst. Preferred curatives for epoxy systems comprise amine anhydrides and catalysts comprise imidazoles.

In additional embodiments of the present invention, suitable resin materials for use as the reactive organic matrix comprise polysiloxanes, phenolics, novolac resins, polyacrylates, polyurethanes, polyimides, polyesters, maleimide resins, cyanate esters, polyimides, polyureas, cyanoacrylates, and combinations thereof. The cure chemistry would be dependent on the polymer or resin utilized in the compound. For example, a siloxane matrix can comprise an addition reaction curable matrix, a condensation reaction curable matrix, a peroxide reaction curable matrix, or a combination thereof.

In a further embodiment of the present invention, the composition comprises optional materials such as solvents, diluents, flame retardants, colorants, cure inhibitors, further viscosity modifiers, and the like.

In one embodiment of the present invention, the composition is provided in a 2-part kit comprising a part-A and a part-B. After compounding, the two parts are stored separately for later reactive, meter-mix processing using a hand-held caulking gun or via automated dispense equipment such as a progressive cavity or positive displacement metering system. Immediately prior to application, the components are mixed and then delivered as a reactive mixture to a substrate and cured in place.

As an alternative to the above-described 2-part system, a 1-part system may be provided as comprising, for example, a hydrolyzable polyfunctional silane or siloxane which is activated by atmospheric moisture, or as a frozen/cold stored composition that will react upon heating to room temperature.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### EXAMPLES

### List of Examples

Table 1: List of anti-settling fillers including embodied “secondary fillers”
Epoxy/aluminum oxide (primary filler) Example:
   Table 2: A-side with no anti-settling filler (baseline)
   Table 3: Baseline+fumed silica (prior art)
   Table 4: Baseline+MgO (secondary filler)
   Table 5: Baseline+HGCB (secondary filler)
   Table 6: B-side used to cure all A-sides formulations listed in Table 2-5
   Table 7: Summary of results
Polyurethane/aluminum oxide (primary filler) Example:
   Table 8: Polyol A-side with no anti-settling filler (baseline)
   Table 9: Polyol Baseline+fumed silica (prior art)
   Table 10: Polyol Baseline+HGCB (secondary filler)
   Table 11: Isocyanate B-side with no anti-settling filler (baseline)
   Table 12: Isocyanate Baseline+fumed silica (prior art)
   Table 13: Isocyanate Baseline+HGCB (secondary filler)
   Table 14: Summary of results
Silicone/aluminum oxide (primary filler) Example:
   Table 15: Vinyl silicone A-side with no anti-settling filler (baseline)
   Table 16: Vinyl Baseline+fumed silica (prior art)
   Table 17: Vinyl Baseline+HGCB (secondary filler)
   Table 18: Hydride silicone B-side with no anti-settling filler (baseline)
   Table 19: Hydride Baseline+fumed silica (prior art)
   Table 20: Hydride Baseline+HGCB (secondary filler)
   Table 21: Summary of results
Silicone/aluminum trihydrate oxide (primary filler) Example:
   Table 22: Vinyl silicone A-side with no anti-settling filler (baseline)
   Table 23: Vinyl Baseline+fumed silica (prior art)
   Table 24: Vinyl Baseline+HGCB (secondary filler)
   Table 25: Hydride silicone B-side with no anti-settling filler (baseline)
   Table 26: Hydride Baseline+fumed silica (prior art)
   Table 27: Hydride Baseline+HGCB (secondary filler)
   Table 28: Summary of results
Summary of dielectric strength

TABLE 1
Comparison of properties of common anti-settling additives of
the prior art and secondary filler of the present invention
comprising a highly graphitized carbon black (HGCB) and magnesium
oxide (MgO) of embodiments of the present invention.

| | Estimated Bulk | Surface |
|---|---|---|
| | Thermal Conductivity | Area |
| Secondary Filler | (W/m · K) | (m²/g) |
| Hexamethyldisilazane-treated fumed | 1.3 | 320 |
| silica (prior art) | | |
| Silicone treated fumed silica (prior art) | 1.3 | 200 |
| Untreated fumed silica (prior art) | 1.3 | 200 |
| Magnesium oxide - MgO | 40 | >160 |
| Highly graphitized carbon black - | 80-300 | 254 |
| HGCB | | |

TABLE 2
Prior art epoxy and aluminum oxide
baseline formulation (A-side only).

| Ingredient | Role | Wt % | Vol % |
|---|---|---|---|
| Diglycidyl ether of bisphenol F | Resin | 6.86 | 17.19 |
| Cycloaliphatic epoxy | Resin | 6.86 | 17.19 |
| Dispersion of 20 wt % carbon black in | Pigment | 0.34 | 0.99 |
| 80 wt % diglycidyl ether of bisphenol A | (color only) | | |
| Spherical aluminum oxide - large | Primary | 62.49 | 46.99 |
| (Average particle size = ~45 microns) | filler | | |
| Spherical aluminum oxide - small | Primary | 23.46 | 17.65 |
| (Average particle size = ~5 microns) | filler | | |
| | TOTAL | 100 | 100 |

Table 2 is the baseline formulation (A-side) containing epoxy resin, black pigment, and primary filler (˜65 vol % in total). This formulation exhibits significant settling especially at the temperatures at which it is typically dispensed, i.e. ≥60° C.

Tables 3-5 are formulations derived from the same baseline but contain very small amounts of the silicone treated fumed silica, MgO, and HGCB listed in Table 1, respectively. Note the black pigment (dispersion of 20 wt % carbon black in 80 wt % diglycidyl ether of bisphenol A) in the baseline formulation was removed from the latter two formulations to demonstrate the ability to color the formulation white and black color, respectively.

TABLE 3
Epoxy/aluminum oxide baseline formulation (A-side)
containing silicone-treated fumed silica.

| Ingredient | Role | Wt % | Vol % |
|---|---|---|---|
| Diglycidyl ether of bisphenol F | Resin | 6.85 | 17.17 |
| Cycloaliphatic epoxy | Resin | 6.85 | 17.17 |
| Dispersion of 20 wt % carbon black in | Black | 0.34 | 0.99 |
| 80 wt % diglycidyl ether of bisphenol A | pigment | | |
| Spherical aluminum oxide - large | Primary | 62.46 | 46.96 |
| (Average particle size = ~45 microns) | filler | | |
| Spherical aluminum oxide - small | Primary | 23.45 | 17.63 |
| (Average particle size = ~5 microns) | filler | | |
| Silicone-treated fumed silica | Non- | 0.05 | 0.07 |
| | conductive | | |
| | anti-settling | | |
| | aid | | |
| | TOTAL | 100 | 100 |

TABLE 4
Epoxy/aluminum oxide baseline formulation (A-
side) containing secondary filler comprising
high surface area, highly conductive MgO.

| Ingredient | Role | Wt % | Vol % |
|---|---|---|---|
| Diglycidyl ether of bisphenol F | Resin | 6.97 | 17.54 |
| Cycloaliphatic epoxy | Resin | 6.97 | 17.54 |
| Spherical aluminum oxide - large | Primary filler | 62.49 | 47.14 |
| (Average particle size = ~45 microns) | | | |
| Spherical aluminum oxide - small | Primary filler | 23.47 | 17.70 |
| (Average particle size = ~5 microns) | | | |
| MgO | Secondary | 0.10 | 0.08 |
| | filler | | |
| | TOTAL | 100 | 100 |

TABLE 5
Epoxy/aluminum oxide baseline formulation (A-side) containing
secondary filler comprising high surface area, HGCB.

| Ingredient | Role | Wt % | Vol % |
|---|---|---|---|
| Diglycidyl ether of Bisphenol F | Resin | 7.00 | 17.58 |
| Cycloaliphatic Epoxy | Resin | 7.00 | 17.58 |
| Spherical aluminum oxide - large | Primary filler | 62.49 | 47.08 |
| (Average particle size = ~45 microns) | | | |
| Spherical aluminum oxide - small | Primary filler | 23.46 | 17.68 |
| (Average particle size = ~5 microns) | | | |
| HGCB | Secondary | 0.05 | 0.08 |
| | filler | | |
| | TOTAL | 100 | 100 |

TABLE 6
B-side formulation used to cure all aforementioned
A-side formulations listed in Tables 2-5.

| Ingredient | Role | Wt % | Vol % |
|---|---|---|---|
| 2-ethyl-4-methylimidazole | Catalyst | 0.068 | 0.20 |
| Nadic methyl anhydride | Curative | 13.555 | 33.16 |
| Spherical aluminum oxide - large | Primary filler | 62.796 | 48.45 |
| (Average particle size = ~45 microns) | | | |
| Spherical aluminum oxide - small | Primary filler | 23.581 | 18.19 |
| (Average particle size = ~5 microns) | | | |
| | TOTAL | 100 | 100 |

Table 6 represents the B-side formulation used to cure each of the A-sides listed in Tables 2-5. The mix ratio of A to B was 1 to 1 by weight. All formulations and combination with that of Table 6 were prepared by mixing the ingredients under vacuum using a DAC800 Hauschild. Degree of settling of the A-side was monitored by inspecting the formulation after sitting 1 hour in preheated oven set at 60° C. The thermal conductivity of the mixed formulation was measured per ASTM E1461 using a Netzsch LFA 447 Nanoflash thermal tester on samples cured for 2 hours at 90° C. followed by 2 hours at 160° C.

TABLE 7
Summary of Results based on epoxy/aluminum
oxide baseline formulation.

| | | Conductivity |
|---|---|---|
| Sample | A-Side Settling Data After 1 h at 60° C. | (W/m · K) |
| Baseline | Settled/Hard Packed at Bottom | 3.4 |
| Baseline + Fumed | No settling | 3.0 |
| Silica | | |
| Baseline + MgO | No settling | 3.7 |
| Baseline + HGCB | No settling | 3.6 |

Table 7 shows the addition of silicone treated fumed silica to the baseline A-side formulation eliminates settling of the aluminum oxide primary filler at room temp and at 60° C., but the thermal conductivity is significantly reduced. On the other hand, using secondary filler compromised of either high surface area, highly conductive MgO or HGCB improves the conductivity while also eliminating settling of the primary filler. Lastly, these two additives enable the creation of an entirely white or black color on the A-side formulation.

TABLE 8
Prior art polyol/aluminum oxide baseline
formulation (A-side) known to settle.

| Ingredient | Role | Wt % | Vol % |
|---|---|---|---|
| Castor oil | Resin | 8.12 | 24.34 |
| 1,4-butanediol | Resin | 3.78 | 10.66 |
| Spherical aluminum oxide - large | Primary filler | 64.31 | 47.45 |
| (Average particle size = ~45 microns) | | | |
| Spherical aluminum oxide - small | Primary filler | 23.79 | 17.55 |
| (Average particle size = ~5 microns) | | | |
| | TOTAL | 100 | 100 |

TABLE 9
Polyol/aluminum oxide baseline formulation (A-
side) containing silicone-treated fumed silica.

| Ingredient | Role | Wt % | Vol % |
|---|---|---|---|
| Castor oil | Resin | 8.14 | 24.34 |
| 1,4-butanediol | Resin | 3.79 | 10.66 |
| Spherical aluminum oxide - large | Primary filler | 64.01 | 47.08 |
| (Average particle size = ~45 microns) | | | |
| Spherical aluminum oxide - small | Primary filler | 23.67 | 17.41 |
| (Average particle size = ~5 microns) | | | |
| Silicone-treated fumed silica | Non- | 0.38 | 0.50 |
| | conductive | | |
| | anti-settling aid | | |
| | TOTAL | 100 | 100 |

TABLE 10
Polyol/aluminum oxide baseline (A-side) containing secondary
filler comprising high surface area, highly conductive, HGCB.

| Ingredient | Role | Wt % | Vol % |
|---|---|---|---|
| Castor Oil | Resin | 8.15 | 24.34 |
| 1,4-butanediol | Resin | 3.79 | 10.66 |
| Spherical aluminum oxide - large | Primary filler | 64.05 | 47.08 |
| (Average particle size = ~45 microns) | | | |
| Spherical aluminum oxide - small | Primary filler | 23.69 | 17.41 |
| (Average particle size = ~5 microns) | | | |
| HGCB | Secondary | 0.31 | 0.50 |
| | filler | | |
| | TOTAL | 100 | 100 |

TABLE 11
Prior art isocyanate/aluminum oxide baseline
formulation (B-side) known to settle.

| Ingredient | Role | Wt % | Vol % |
|---|---|---|---|
| Polymeric diphenylmethane-diisocyanate | Curative | 14.62 | 35.00 |
| Spherical aluminum oxide - large | Primary | 62.33 | 47.45 |
| (Average particle size = ~45 microns) | filler | | |
| Spherical aluminum oxide - small | Primary | 23.05 | 17.55 |
| (Average particle size = ~5 microns) | filler | | |
| | TOTAL | 100 | 100 |

TABLE 12
Isocyanate/aluminum oxide baseline formulation (B-
side) containing silicone-treated fumed silica.

| Ingredient | Role | Wt % | Vol % |
|---|---|---|---|
| Polymeric diphenylmethane- | Curative | 14.66 | 35.00 |
| diisocyanate | | | |
| Spherical aluminum oxide - large | Primary filler | 62.03 | 47.08 |
| (Average particle size = ~45 microns) | | | |
| Spherical aluminum oxide - small | Primary filler | 22.94 | 17.41 |
| (Average particle size = ~5 microns) | | | |
| Silicone-treated fumed silica | Non- | 0.37 | 0.50 |
| | conductive | | |
| | anti-settling aid | | |
| | TOTAL | 100 | 100 |

TABLE 13
Isocyanate/aluminum oxide baseline formulation
(B-side) containing secondary filler comprising
high surface area, highly conductive, HGCB.

| Ingredient | Role | Wt % | Vol % |
|---|---|---|---|
| Polymeric diphenylmethane- | Curative | 14.67 | 35.00 |
| diisocyanate | | | |
| Spherical aluminum oxide - large | Primary filler | 62.07 | 47.08 |
| (Average particle size = ~45 microns) | | | |
| Spherical aluminum oxide - small | Primary filler | 22.96 | 17.41 |
| (Average particle size = ~5 microns) | | | |
| HGCB | Secondary | 0.30 | 0.50 |
| | filler | | |
| | TOTAL | 100 | 100 |

All A-side and B-side formulations were prepared by mixing the ingredients under vacuum using a DAC800 Hauschild. Degree of settling of the A-side was monitored by inspecting the formulation after sitting 1 hour in preheated oven set at 60° C. Measurements of the height of the fluid layer on the top of the material after settling. Settling was not measured on the B-side formulation due to the reactivity of the isocyanate at elevated temperatures. The thermal conductivity of the mixed formulation was measured per ISO 22007-2 using a Hot Disk TPS 2500S thermal conductivity tester on samples cured for 5 days at room temperature. The mixed formulation was prepared by dispensing the A and B sides from 1:1 by volume cartridge.

TABLE 14
Summary of urethane/aluminum oxide results.

| | | Conductivity |
|---|---|---|
| Sample | A-Side Settling Data After 18 h at 60° C. | (W/m · K) |
| Baseline | 2 mm fluid layer on top/37 mm material | 3.0 |
| Baseline + | 1 mm fluid layer on top/37 mm material | 2.8 |
| fumed silica | | |
| Baseline + | 1 mm fluid layer on top/37 mm material | 3.0 |
| HGCB | | |

Table 14 compares the settling behavior of the polyol/aluminum oxide (A-side) and the thermal conductivity of the mixed and cured formulations formulation containing no anti-settling additive, fumed silica, and secondary filler based on HGCB. Both the fumed silica and HGCB lead to less settling of the A-side; however, the fumed silica reduces the thermal conductivity of the baseline, whereas the HGCB maintains the conductivity of the baseline containing no anti-settling additive.

TABLE 15
Prior art vinyl-silicone/aluminum oxide baseline
formulation (A-side) known to settle.

| Ingredient | Role | Wt % | Vol % |
|---|---|---|---|
| Vinyl-functional silicone fluid | Resin | 11.71 | 34.70 |
| Platinum catalyst in vinyl polymer, | Hydrosilylation | 0.10 | 0.30 |
| 0.5 wt % concentration | catalyst | | |
| Spherical aluminum oxide - large | Primary filler | 64.38 | 47.45 |
| (Average particle size = ~45 microns) | | | |
| Spherical aluminum oxide - small | Primary filler | 23.81 | 17.55 |
| (Average particle size = ~5 microns) | | | |
| | TOTAL | 100 | 100 |

TABLE 16
Vinyl-silicone/aluminum oxide baseline formulation
(A-side) containing untreated fumed silica.

| Ingredient | Role | Wt % | Vol % |
|---|---|---|---|
| Vinyl-functional silicone fluid | Resin | 11.75 | 34.72 |
| Platinum catalyst in vinyl polymer, | Hydrosilylation | 0.10 | 0.29 |
| 0.5 wt % concentration | catalyst | | |
| Spherical aluminum oxide - large | Primary filler | 64.07 | 47.08 |
| (Average particle size = ~45 microns) | | | |
| Spherical aluminum oxide - small | Primary filler | 23.70 | 17.42 |
| (Average particle size = ~5 microns) | | | |
| Untreated fumed silica | Non- | 0.38 | 0.50 |
| | conductive | | |
| | anti-settling aid | | |
| | TOTAL | 100 | 100 |

TABLE 17
Vinyl-silicone/aluminum oxide baseline formulation
(A-side) containing secondary filler comprising
high surface area, highly conductive HGCB.

| Ingredient | Role | Wt % | Vol % |
|---|---|---|---|
| Vinyl-functional silicone fluid | Resin | 11.76 | 34.72 |
| Platinum catalyst in vinyl polymer, | Hydrosilylation | 0.10 | 0.29 |
| 0.5 wt % concentration | catalyst | | |
| Spherical aluminum oxide - large | Primary filler | 64.12 | 47.08 |
| (Average particle size = ~45 microns) | | | |
| Spherical aluminum oxide - small | Primary filler | 23.71 | 17.41 |
| (Average particle size = ~5 microns) | | | |
| HGCB | Secondary | 0.31 | 0.50 |
| | filler | | |
| | TOTAL | 100 | 100 |

TABLE 18
Prior art hydride-silicone/aluminum oxide baseline
formulation (B-side) known to settle.

| Ingredient | Role | Wt % | Vol % |
|---|---|---|---|
| Hydride-functional silicone chain | Resin/chain | 5.86 | 17.35 |
| extender | extender | | |
| Hydride-functional crosslinker | Resin/ | 0.54 | 1.59 |
| | crosslinker | | |
| Vinyl-functional silicone fluid | Resin | 5.41 | 16.04 |
| Inhibitor | Cure inhibitor | 0.01 | 0.02 |
| Spherical aluminum oxide - large | Primary filler | 64.37 | 47.45 |
| (Average particle size = ~45 microns) | | | |
| Spherical aluminum oxide - small | Primary filler | 23.81 | 17.55 |
| (Average particle size = ~5 microns) | | | |
| | TOTAL | 100 | 100 |

TABLE 19
Hydride-silicone/aluminum oxide baseline formulation
(B-side) containing untreated, fumed silica.

| Ingredient | Role | Wt % | Vol % |
|---|---|---|---|
| Hydride-functional silicone chain | Resin/chain | 5.87 | 17.35 |
| extender | extender | | |
| Hydride-functional crosslinker | Resin/ | 0.54 | 1.58 |
| | crosslinker | | |
| Vinyl-functional silicone fluid | Resin | 5.43 | 16.05 |
| Inhibitor | Cure inhibitor | 0.01 | 0.02 |
| Spherical aluminum oxide - large | Primary filler | 64.07 | 47.09 |
| (Average particle size = ~45 microns) | | | |
| Spherical aluminum oxide - small | Primary filler | 23.70 | 17.42 |
| (Average particle size = ~5 microns) | | | |
| Untreated fumed silica | Non- | 0.38 | 0.50 |
| | conductive | | |
| | anti-settling aid | | |
| | TOTAL | 100 | 100 |

TABLE 20
Hydride-silicone/aluminum oxide baseline formulation
(B-side) containing secondary filler comprising
high surface area, highly conductive HGCB.

| Ingredient | Role | Wt % | Vol % |
|---|---|---|---|
| Hydride-functional silicone chain | Resin/chain | 5.87 | 17.33 |
| extender | extender | | |
| Hydride-functional crosslinker | Resin/ | 0.54 | 1.58 |
| | crosslinker | | |
| Vinyl-functional silicone fluid | Resin | 5.44 | 16.06 |
| Inhibitor | Cure inhibitor | 0.01 | 0.02 |
| Spherical aluminum oxide - large | Primary filler | 64.12 | 47.10 |
| (Average particle size = ~45 microns) | | | |
| Spherical aluminum oxide - small | Primary filler | 23.71 | 17.41 |
| (Average particle size = ~5 microns) | | | |
| HGCB | Secondary | 0.31 | 0.50 |
| | filler | | |
| | TOTAL | 100 | 100 |

All A-side and B-side formulations were prepared by mixing the ingredients under vacuum using a DAC800 Hauschild. Both A-side and B-side baseline formations were prone to settling. Degree of settling of was monitored by the formulation after sitting 1 hour in preheated oven set at 60° C. The thermal conductivity of the mixed formulation was measured per ISO 22007-2 using a Hot Disk TPS 2500S thermal conductivity tester on samples cured for 1 hour at 100° C. The mixed formulation was prepared by mixing the A and B sides as a 1:1 ratio by weight under vacuum using a DAC800 Hauschild.

TABLE 21
Summary of silicone/aluminum oxide results.

| | | | Thermal |
|---|---|---|---|
| | Settling Data After 1 h at 60° C.: | | Conductivity |
| Sample | A-side | B-side | (W/m · K) |
| Baseline | Settled/Hard | Settled/Hard | 2.0 |
| | Packed at Bottom | Packed at Bottom | |
| Baseline + fumed | No settling | No settling | 1.7 |
| silica | | | |
| Baseline + | No settling | No settling | 2.1 |
| untreated HGCB | | | |

Table 21 compares the settling behavior of the silicone A-side and B-side formulations and the thermal conductivity of the mixed and cured formulations containing aluminum oxide primary filler either no anti-settling additive (baseline), fumed silica, and secondary filler based on HGCB. Both the fumed silica and HGCB lead to no settling of the A-side; however, the fumed silica reduces the thermal conductivity of the baseline, whereas the HGCB maintains the conductivity of the baseline containing no anti-settling additive.

TABLE 22
Prior art vinyl-silicone/aluminum trihydrate baseline
formulation (A-side) known to settle.

| Ingredient | Role | Wt % | Vol % |
|---|---|---|---|
| Vinyl-functional silicone fluid | Resin | 17.65 | 34.80 |
| Platinum catalyst in vinyl polymer, | Hydrosilylation | 0.10 | 0.20 |
| 0.5 wt % concentration | catalyst | | |
| Alumina trihydrate | Primary filler | 82.25 | 65.00 |
| (Average particle size = ~45 microns) | | | |
| | TOTAL | 100 | 100 |

TABLE 23
Vinyl-silicone/aluminum trihydrate baseline formulation
(A-side) containing untreated, fumed silica.

| Ingredient | Role | Wt % | Vol % |
|---|---|---|---|
| Vinyl-functional silicone fluid | Resin | 17.66 | 34.80 |
| Platinum catalyst in vinyl polymer, | Hydrosilylation | 0.10 | 0.20 |
| 0.5 wt % concentration | catalyst | | |
| Alumina trihydrate | Primary filler | 81.66 | 64.50 |
| (Average particle size = ~45 | | | |
| microns) | | | |
| Untreated fumed silica | Non-conductive | 0.58 | 0.50 |
| | Anti-settling aid | | |
| | TOTAL | 100 | 100 |

TABLE 24
Vinyl-silicone/aluminum trihydrate baseline formulation
(A-side) containing secondary filler comprising
high surface area, highly conductive HGCB.

| Ingredient | Role | Wt % | Vol % |
|---|---|---|---|
| Vinyl-functional silicone fluid | Resin | 17.68 | 34.80 |
| Platinum catalyst in vinyl polymer, | Hydrosilylation | 0.10 | 0.20 |
| 0.5 wt % concentration | catalyst | | |
| Alumina trihydrate | Primary filler | 81.75 | 64.50 |
| (Average particle size = ~45 microns) | | | |
| HGCB | Secondary | 0.47 | 0.50 |
| | filler | | |
| | TOTAL | 100 | 100 |

TABLE 25
Hydride-silicone/aluminum trihydrate baseline
formulation (B-side) known to settle.

| Ingredient | Role | Wt % | Vol % |
|---|---|---|---|
| Hydride-functional silicone chain | Resin/chain | 8.83 | 17.42 |
| extender | extender | | |
| Hydride-functional crosslinker | Resin/ | 0.80 | 1.58 |
| | crosslinker | | |
| Vinyl-functional silicone fluid | Resin | 8.11 | 15.99 |
| Inhibitor | Cure inhibitor | 0.01 | 0.01 |
| Alumina trihydrate | Primary filler | 82.25 | 65.00 |
| (Average particle size = ~45 microns) | | | |
| | TOTAL | 100 | 100 |

TABLE 26
Hydride-silicone/aluminum trihydrate baseline formulation
(B-side) containing untreated, fumed silica.

| Ingredient | Role | Wt % | Vol % |
|---|---|---|---|
| Hydride-functional silicone chain | Resin/chain | 8.84 | 17.42 |
| extender | extender | | |
| Hydride-functional crosslinker | Resin/ | 0.80 | 1.58 |
| | crosslinker | | |
| Vinyl-functional silicone fluid | Resin | 8.12 | 15.99 |
| Inhibitor | Cure inhibitor | 0.01 | 0.01 |
| Alumina trihydrate | Primary filler | 81.66 | 64.50 |
| (Average particle size = ~45 microns) | | | |
| Untreated fumed silica | Non- | 0.58 | 0.50 |
| | conductive | | |
| | anti-settling aid | | |
| | TOTAL | 100 | 100 |

TABLE 27
Hydride-silicone/aluminum trihydrate baseline formulation (B-
side) containing high surface area, highly conductive HGCB.

| Ingredient | Role | Wt % | Vol % |
|---|---|---|---|
| Hydride-functional silicone chain | Resin/chain | 8.85 | 17.42 |
| extender | extender | | |
| Hydride-functional crosslinker | Resin/ | 0.80 | 1.58 |
| | crosslinker | | |
| Vinyl-functional silicone fluid | Resin | 8.13 | 15.99 |
| Inhibitor | Cure inhibitor | 0.01 | 0.01 |
| Alumina trihydrate | Primary filler | 81.75 | 64.50 |
| (Average particle size = ~45 microns) | | | |
| HGCB | Secondary | 0.47 | 0.50 |
| | filler | | |
| | TOTAL | 100 | 100 |

All A-side and B-side formulations were prepared by mixing the ingredients under vacuum using a DAC800 Hauschild. Both A-side and B-side baseline formations were prone to settling. Degree of settling of was monitored by inspecting the formulation after sitting 1 hour in preheated oven set at 60° C. The thermal conductivity of the mixed formulation was measured per ISO 22007-2 using a Hot Disk TPS 2500S thermal conductivity tester on samples cured for 1 hour at 100° C. The mixed formulation was prepared by mixing the A and B sides as a 1:1 ratio by weight under vacuum using a DAC800 Hauschild.

TABLE 28
Summary of silicone/aluminum trihydrate results.

| | | | Thermal |
|---|---|---|---|
| | Settling Data After 1 h at 60° C.: | | Conductivity |
| Sample | A-Side | B-Side | (W/m · K) |
| Baseline | Settled/Hard | Settled/Hard | 1.9 |
| | Packed at Bottom | Packed at Bottom | |
| Baseline + | No settling | No settling | 1.8 |
| untreated fumed | | | |
| silica | | | |
| Baseline + HGCB | Minimal settling | Minimal settling | 1.9 |

Table 28 compares the settling behavior of the silicone A-side and B-side formulations and the thermal conductivity of the mixed and cured formulations containing aluminum trihydrate primary filler either no anti-settling additive (baseline), fumed silica, and secondary filler based on HGCB. Both the fumed silica and HGCB lead to no to minimal settling of the A-side; however, the fumed silica reduces the thermal conductivity of the baseline, whereas the HGCB maintains the conductivity of the baseline containing no anti-settling additive.

TABLE 29
Summary of dielectric strength data for cured
samples contained in above examples.

| | | Thick- | Dielectric |
|---|---|---|---|
| | | ness | Strength |
| Example | Formulation | (mm) | (kV/mm) |
| 3 | Epoxy/Aluminum Oxide/Treated | 2.2 | 15.1 |
| | Fumed Silica | | |
| 5 | Epoxy/Aluminum Oxide/HGCB | 2.2 | 15.9 |
| 9 | Urethane/Aluminum Oxide/Treated | 1.2 | 14.2 |
| | Fumed Silica | | |
| 10 | Urethane/Aluminum Oxide/HGCB | 1.4 | 3.6 |
| 16 | Silicone/Aluminum Oxide/Untreated | 1.7 | 14.6 |
| | Fumed Silica | | |
| 17 | Silicone/Aluminum Oxide/HGCB | 1.2 | 7.2 |
| 23 | Silicone/Aluminum Trihydrate/ | 1.4 | 12.1 |
| | Untreated Fumed Silica | | |
| 24 | Silicone/Aluminum Trihydrate/HGCB | 1.8 | 10.3 |

Table 29 summarizes the dielectric strength measured according to ASTM D149 on cured formulations containing fumed silica (prior art) and secondary fillers. In all cases the secondary filler provides electrically insulating properties with dielectric strength above 3 kV/mm. This effect is especially noteworthy for examples contains electrically conductive HGCB.

What is claimed is:

1. A composition comprising:
a reactive organic matrix;
a thermally conductive primary filler comprising at least 50 volume percent based on the total volume of the composition, an average particle size of at least about 5 microns, and a thermal conductivity of at least about 15 W/mK; and
a thermally conductive secondary filler comprising particles having an average particle size of less than 100 nm agglomerating together to form an aggregate having an irregular structure and comprising a measurement in a longest dimension of greater than 400 nm.

2. The composition of claim 1, wherein the primary filler comprises an approximately spherical shape.

3. The composition of claim 1, wherein the secondary filler comprises a thermal conductivity of at least about 10 W/mK.

4. The composition of claim 1, wherein the primary filler comprises an average particle size of at least about 25 microns.

5. The composition of claim 1, wherein the primary filler comprises a thermal conductivity of at least about 20 W/mK.

6. The composition of claim 1, wherein the primary filler comprises a metal oxide.

7. The composition of claim 1, wherein primary filler comprises a surface area of less than about 10 m²/g.

8. The composition of claim 1, wherein the secondary filler is present in an amount less than about 1.0 volume percent based on the total volume of the composition.

9. The composition of claim 8, wherein the secondary filler is present in an amount less than about 0.5 volume percent based on the total volume of the composition.

10. The composition of claim 1, wherein the secondary filler comprises a surface area of at least about 100 m²/g.

11. The composition of claim 1, wherein the secondary filler aggregates comprise a measurement in a longest dimension of at least about 400 nm.

12. The composition of claim 1, wherein the secondary filler comprises particles having an average particle size of about 10 nanometers to about 50 nanometers.

13. The composition of claim 1, wherein the secondary filler comprises at least one of magnesium oxide or graphitized carbon black.

14. The composition of claim 1, wherein the reactive organic matrix comprises at least one of an epoxy, an acrylate, a urethane, or a silicone.

15. The composition of claim 1, further comprising a curative.

16. The composition of claim 1, wherein the reactive organic matrix has been cured.

17. The composition of claim 1, wherein at least one of the primary filler and secondary filler comprise electrically conductive particles.

18. The composition of claim 1, wherein a dielectric strength of the composition cured comprises at least 3 kV/mm.

19. The composition of claim 1, wherein the secondary particles have been surface treated.

20. The composition of claim 1, wherein the secondary particles have been treated with at least one of hexamethyldisilzane or polydimethylsiloxane.
